(19) United States
(12) Patent Application Publication
(10) Pub. No.: US 2023/0062758 A1
(43) Pub. Date: Mar. 2, 2023

(54) METHOD AND DEVICE FOR MIXING AND SUPPLYING PLASTIC INTO A MOLD FOR A VACUUM INFUSION

(71) Applicant: Udo Tartler, Luetzelbach/Haingrund (DE)

(72) Inventor: Udo Tartler, Luetzelbach/Haingrund (DE)

(21) Appl. No.: 17/792,589

(22) PCT Filed: Jan. 15, 2021
(86) PCT No.: PCT/IB2021/050282

§ 371 Date: Jul. 13, 2022

(30) Foreign Application Priority Data
Jan. 15, 2020 (DE) 10 2020 100 814.7

(51) Int. Cl. B29B 7/72; B01F 35/83; B01F 35/21; B01F 35/221; B01F 23/70; B01F 27/213; B29C 70/54; B29C 70/48; B29B 7/40

(52) U.S. Cl. CPC B29B 7/72; B01F 35/831; B01F 35/2113; B01F 35/2217; B01F 23/703; B01F 27/213; B29C 70/546; B29C 70/48; B29B 7/407; B29B 7/404; B01F 2101/2805

(57) ABSTRACT

A method and device for mixing plastic from liquid components in a mixer (8) and conveying it through a line (10) into a mould (12), in particular for vacuum infusion, characterised in that the components are each pumped by means of a pump (24) from their own respective component container (22) into a mixer (8) and are mixed therein, that these volume flows are controlled by a controller (26) in such a manner that they supply the components to the mixer (8) in a specific ratio, that the pressure loss in the line (10), between a pressure sensor in one of the component supply lines (32) leading to the mixer (8) and the mould (12), is determined, and that the pressure is measured by the pressure sensor and supplied to a controller (26) which, taking into consideration the determined pressure loss, controls the volume flows such that the pumps (24) supply the components to the mixer (8) at a pressure that is greater than the ambient pressure or than another specific pressure that should not be exceeded in the mould (12) by at most the pressure loss.

The present invention is directed at the technical improvement of a method and device for mixing plastic (in particular thermoset) made of liquid components in a mixer and conveying it through a line into a mould, in particular for vacuum infusion, at a pressure below the ambient pressure (or below another specific maximum pressure in the mould).

Known for example but not least for the production of wind blades for wind turbines is a manufacturing process, the so-called vacuum infusion process or Vacuum Assisted Resin Transfer Moulding (VARTM), in which a thermosetting plastic is applied whilst still liquid to a rigid mould that corresponds in a complementary manner to an outer side of the component, i.e. in the case of wind blades, for example, the front or rear side thereof. There, the plastic impregnates fibre layers, in particular of glass, so that the component, in particular a component shell, of fibre-reinforced plastic is formed once the thermoset has cured in the mould. The plastic is applied to the rigid mould surface underneath a film, the intermediate space being placed under “vacuum”, i.e. subjected to negative pressure. This negative pressure inter alia ensures that the plastic is free from air pockets—which would be weak points after curing and could even be predetermined breaking points of the component.

Various technical problems must be overcome in this process, in particular in the case of large-area components such as wind blades. For example, the flow of the still liquid plastic, in particular as a thermoset mixed from (at least) two liquid components, of course requires a pressure gradient from the mixer to the mould. However, the pressure in the mould in the intermediate space underneath the “vacuum film” may not exceed the ambient pressure, not least because otherwise the mould would be “blown up”. In order to monitor this, it is known and common to provide pressure sensors in the plastic supply lines and/or on the mould. However, keeping these sensors accurate, i.e. in particular also cleaning them regularly, presents a significant challenge in view of the mixed, already reacting plastic as a contaminating liquid, which cures in an exothermic reaction, i.e. whilst generating heat: The sensors must be cleaned and/or replaced regularly since they have become inaccurate and unusable due to cured plastic at the sensitive measurement points. However, these sensors are also disadvantageous even during functional operation, not least due to the required number thereof, since, employed at each of the plurality of plastic supply lines and in particular at the introduction points into the mould, they each represent a challenge at these locations as regards, for example, tightness and also accessibility since each of these sensors must be wired over considerable distances.

EP2656991A2 is directed at a known prior art for such a manufacturing process. The thermoset is mixed from its liquid components in a mixing head and conveyed into a storage container with flexible walls. This is a further development as compared to the so-called “open-bucket” process, in which the mixed thermoset is stored in an open container—with the additional disadvantage, for example, of being exposed to ambient air therein, which may possibly counteract any prior degassing of the components since the mixture again absorbs air and air moisture. The thermoset in the storage container that is pre-produced in this manner and is still stored in liquid form is thus in any case at ambient pressure in the prior art—and the pressure gradient required for flow from there to the mould requires a—considerable—negative pressure in the intermediate space of the mould, which compensates both pressure loss due to friction in the line (which could possibly be quite long, for example in the case of wind blades measuring many tens of meters) and hydrostatic pressure due to the difference in level between the storage container and the mould. A further challenge of this common technology is to ensure that the already mixed plastic remains capable of flowing—which slows down the process since, for example, it prohibits the use of fast-curing thermosets. Or, to put it another way, it requires the thermoset to be “configured” in such a manner that curing thereof is delayed such that it is certain that curing will only take place in the mould, and not already in the flow path leading to the mould. This challenge is particularly great as regards the aforementioned common storage container of the prior art (namely both as an “open bucket” and according to EP2656991A2): due to a locally concentrated, thermal, i.e. exothermic reaction, the plastic mixed therein in its compact mass reserve poses a considerable safety risk for workers and the environment owing to heat, toxic smoke generation and fire.

The object of the present invention is to provide a method and device for mixing plastic, in particular thermoset components, and bringing it into a mould at a certain pressure, in particular for vacuum infusion below the ambient pressure, the efficiency of which is improved. This object is solved by a method having the features of claim 1 and a device having the features of claim 2. Preferred embodiments are specified in the sub-claims.

The invention relates to a method that, for example, does not require any stockpiling of already mixed plastic—i.e. which enables mixing “on-demand”, so to speak. It is a method for mixing plastic (in particular thermoset) from liquid components (in particular two or more—“multiple”—components) in a mixer and conveying it through a line into a mould, in particular for vacuum infusion, at a pressure below the ambient pressure (or, for instance in a process other than the VARTM process, at a pressure not greater than another specific pressure that should not be exceeded in the mould). The invention also relates to a device for performing this method.

The vacuum infusion process has already been described by way of example above:

The plastic is applied whilst it is still liquid to a rigid mould that corresponds in a complimentary manner to an outer side of the component. The plastic is applied to the rigid mould surface underneath a film, the intermediate space being placed under “vacuum”, i.e. subjected to negative pressure. In this intermediate space, the plastic impregnates fibre layers (for example woven fabric and/or laid fabric, in particular of glass but also of, for instance, carbon or other fibres) so that the component of fibre-reinforced plastic is formed once the plastic has cured—i.e. in particular a component shell (or half shell) since only the side formed by the rigid mould, and not the film side, can be reproduced in a dimensionally accurate manner. The vacuum in the mould ensures that pockets of air which might otherwise form weak points later on are extracted—and in particular also that the liquid plastic is drawn into the fibre layers as a matrix. However, the pressure in the mould in the intermediate space underneath the “vacuum film” may not exceed the ambient pressure, not least because otherwise the film side of the mould would be “blown up”.

According to the invention, the method now includes the steps of pumping the components from their own respective component container, in particular by means of a pump, into a mixer and mixing them therein. These volume flows, in particular the (respective) pump, are controlled by a controller (in particular a programmable logic controller) in such a manner that the components are supplied to the mixer in a specific (volume flow) ratio—preferably in the ratio required by the plastic to be produced. The volume flows are, in particular each, preferably measured by a volumetric flow meter or mass flow meter, in particular in a line section between the component container and the mixer, and the measured values are supplied to the controller. According to the invention, the volume flow (again in particular the (respective) pump) is furthermore controlled by a controller (in particular a programmable logic controller)—by measuring the pressure in at least one of the component supply lines—in such a manner that the components are finally introduced into the mould at a pressure lower than the ambient pressure (in order, as described above, not to “blow up” the mould—or at a pressure lower than another specific pressure which should not be exceeded in the mould, for example, in a process other than the VARTM process). This means that, according to the invention, the pressure in the pressure sensor (according to the invention in the material supply line of the mixer, in particular the mixing head) is adjusted such that it is greater than the pressure (for example ambient pressure) that should not be exceeded in the mould by at most the pressure loss in the line—namely by the pressure loss in that line (or a section thereof—more on this later) which leads from the pressure sensor to the mould.

How this is made possible according to the invention will be explained below, but first of all a significant advantage that is achieved according to the invention should be mentioned as an example: Owing to the pressure compensation control, the mixed plastic can be supplied to the mould at the highest possible pressure since the pressure loss in the length of tube from the mixer to the mould is also taken into consideration.

According to the invention, the pressure in the liquid plastic is measured prior to mixing, preferably by a pressure sensor in (at least) one of the component supply lines to the mixer (i.e. in the material inlet of the individual components to the mixer, preferably just before the mixer), possibly directly in the so-called mixing head (more details below).

The pressure sensor is therefore—and this is a further advantage according to the invention—only exposed to one of the more harmless liquid components of the plastic that has not yet been mixed, and not, as is the case in the prior art, to the already mixed, already reacting, curing plastic that regularly renders the sensors at the sensitive measurement points inaccurate and unusable.

According to the invention, after input and/or supply of the data of the line pressure loss, the controller thus controls the component volume flows—and in particular the volume flow in the component supply line with the pressure sensor, even if (at least) one pressure sensor is only arranged in one of the component supply lines—in particular in such a manner that the component(s) is/are supplied to the pressure sensor (and subsequently, with a possibly already slightly deviating pressure, to the mixer) at a pressure that is greater than the ambient pressure (or another specific pressure that should not be exceeded in the mould) by at most the line pressure loss between the pressure sensor and the mould. According to the invention, it can therefore be ensured, for example in the VARTM process, that the film side of the mould is not blown up, even without having to measure the pressure in the mould, possibly laboriously at a plurality of locations as is the case in the prior art, and in particular without having to measure it anywhere at all in the already mixed, still liquid plastic.

If a pressure sensor is arranged in the two (or more) component supply lines (in each case in the direction of flow, preferably just upstream of the mixer), these sensors will measure the same pressure when performing the method according to the invention. However, in order not to have to stop the method according to the invention in the event, for example, of the failure of a pressure sensor, it is particularly preferred to arrange a second pressure sensor not (as just described) in the other component supply line (to the at least one component supply line according to the invention), but rather (for example by means of a line T-piece) in the same component supply line (in particular as a standby-only replacement).

Fast control may be required for the control objective according to the invention since the pressure ratios in particular in a VARTM can change quickly. For this purpose, a PID controller (but also other fast controllers) has, for example, proven to be advantageous as a component of the controller according to the invention.

According to the invention, the pressure loss in the line between the pressure sensor and the mould (or in a specific section of the line, in particular a section that is important for pressure loss) can be measured (in particular offline, i.e. determined in a preliminary test, for example), but can in particular (also) be calculated. The pressure loss occurs due to known laws of fluid mechanics, and thus the measurement and calculation thereof are possible and objective, and are in particular not subject to any human discretion. According to the invention, rheological effects and dynamic pressure losses, due for example and in particular to fluid viscosity and fluid friction in the line, are also taken into consideration in the mixer (possibly also with respect to their temperature dependency—in particular in such a case the temperature during the process is preferably also measured by suitable sensor technology in the vicinity and/or in and/or on the lines, possibly also controlled and/or taken into consideration by the respective controller), but particularly preferably also the hydrostatic conditions, i.e. pressure loss (or increase) due to the amount of rise (or fall) between the pressure measurement point and the mould.

To summarise again, a mould that is under vacuum can, for example, thus be filled in the shortest possible time according to the invention such that the pressure in the mould nevertheless does not increase to or in particular above atmospheric pressure—and this without measuring the pressure in the mould or anywhere else in the already mixed plastic. According to the invention, the introduction of the components can be controlled in such a manner that pressure changes, which may occur, for example, due to the degree of filling of the mould or to changes in density or temperature or to changes made to the application hose, are “compensated”: According to the invention, the mould can thus always be filled at high speed without exceeding the desired pressure (below ambient pressure).

According to the invention, the pressure of the components can be measured in the dosing system for this purpose, and, by means of a compensation calculation, the measurement point of the pressure sensor can be “shifted” as if the pressure sensor were connected directly to the mould. In this manner, the system can control the maximum output that is possible in this device assembly.

The parameters material data, material temperature, output of the mixed components, type, structure and length of the application hose can in particular be taken into consideration in this calculation.

As stated above, the invention also relates to a device for carrying out this method, i.e. for mixing plastic from liquid components in a mixer and conveying it through a line into a mould, in particular for vacuum infusion, at a pressure below the ambient pressure (or below another specific pressure that should not be exceeded in the mould). The device according to the invention accordingly comprises:
at least one pump that is configured to pump the components from their own respective component container into a mixer that is configured to mix the components, and
a controller (in particular a programmable logic controller) that is configured to control these volume flows in such a manner that the components are supplied to the mixer in a specific ratio, and
a device for inputting and/or measuring the pressure loss in (at least one specific section of) the line between a pressure sensor in (at least) one of the component supply lines leading to the mixer (i.e. in the material inlet to the mixer) and the mould (namely in particular due to friction and taking into consideration the hydrostatic conditions), and
a controller (in particular a programmable logic controller) that is configured to control, taking into consideration a determined pressure loss, the volume flow in the component supply line of the pressure sensor such that this component is supplied to the pressure sensor (and from there to the mixer) at a pressure measured by the pressure sensor that is greater than the ambient pressure or than another specific pressure that should not be exceeded in the mould by at most the pressure loss.

It is particularly preferred according to the invention for the at least one pressure sensor to be arranged immediately upstream of the mixer in one of the component supply lines, possibly in a mixing head assembly, possibly with a drive device for a dynamic mixer insert as a mixer (more on this later).

According to the invention, it is possible for the line to comprise a line section or main line strand from the measurement point or mixer to a line manifold, as well as a plurality of local lines (also of different lengths) leading from the line manifold into the mould. This allows the mixed plastic to be guided from the mixer to the manifold through the main line strand and, from the manifold, is introduced via branches into the mould at a plurality of points under the film. The amount of pressure loss in the local lines is then preferably determined (i.e. measured and/or calculated) as being the amount of pressure loss in the local line with the lowest pressure loss (in most cases the shortest line, inter alia in the case of identical cross-sections) and is supplied to the controller to be taken into consideration during control. Since these local lines run parallel to one another from the manifold into the mould, taking into consideration only one of the local lines, in particular the one with the lowest pressure loss, logically ensures that the pressure balance according to the invention in each of the introduction points from the local lines into the mould results in a line pressure that is lower than the ambient pressure. Even taking into consideration the pressure loss in just one line section, for example in just the main line strand, will reliably ensure this according to the invention. The reason for this is that due to its logically shorter length than the whole line, a lower pressure loss will also be determined (in particular calculated and/or measured) in the line section. Since the volume flow is controlled according to the invention in such a manner that the pressure upstream of the mixer, namely at the pressure sensor, is greater than the ambient pressure by (at most) the pressure loss, the inlet fluid pressure into the mould will (given an actually even higher whole line pressure loss) accordingly be more significantly below ambient pressure (or another specific maximum pressure).

As already mentioned, a conventional so-called mixing head with dynamic or also static mixing may be used in an embodiment according to the invention:

For the production of plastic prior to further processing, for example prior to introduction into the sprue of an injection mould, it is also the case for many plastics, in particular thermosets such as epoxy, that at least two liquid components are mixed together such that the resulting, in particular liquid (or also viscous, paste-like) mixture crosslinks. The component mixture is commonly forwarded for processing through a tubular passage, the—static—mixing insert, with turbulators in the interior thereof that deflect, divert and/or locally accumulate the fluid flowing therethrough, generate turbulence and/or swirl and thus mix the fluid flowing therethrough, possibly locally immediately before processing the plastic. As is known, supply lines lead into this mixer, in particular in the same number as liquid components. A pressure sensor is often arranged in at least one of the supply lines, which measures the fluid pressure in the still unmixed, i.e. not yet reacting, component.

According to the invention, mixing takes place locally at a considerable distance from the processing of the plastic, in particular vacuum injection thereof into the intermediate space between the mould and the film. However, using the method and/or device according to the invention, such a conventional mixing head is also suitable as a mixer within the meaning of the invention and, optionally, its (at least one) pressure sensor as a sensor within the meaning of the invention. This also applies to the so-called dynamic mixer:

To ensure that the components are mixed as uniformly and completely as possible, it has proven to be advantageous and become established to configure the turbulators in the tubular passage such that they rotate. Known mixing heads have at least two component supply lines as well as a rotary drive with a drive shaft. Such a device or mixing machine is then adjusted to place the tubular passage member (mixer tube) in fluid-tight conducting connection with the component supply lines, and to place a rotary drive connecting structure in rotary drive connection with a mixer insert (typically comprising a number of turbulators and being configured for use in the passage member) when the mixer insert is inserted into the passage member and the passage member is placed in conducting connection with the component supply lines. In known mixer inserts, such a rotary drive connecting structure is generally an opening lying substantially radial to the axis of rotation, into which a hook at the end of the drive shaft is hooked in order to create the drive connection, or is, for example, a self-tapping thread at the end of the drive shaft that can cut into a matching axial bore at one end of the mixer insert. The mixer tube and mixer insert, which together are also called mixers, as well as the above-described static mixers may (also according to the invention) be single-use or disposable articles.

A stirrer (for example to homogenise the component) and/or a heater (for example to keep the component temperature constant, which may be taken into consideration in the control according to the invention) may be provided in the component containers. The component containers may be under vacuum. In the method according to the invention, the components and the mixed liquid plastic no longer need to be exposed to a gaseous atmosphere before and ultimately until entering the mould, rather, if at all, to an adjacent cavity not filled with liquid, and then under vacuum.

Further advantages, configurations and details of the invention are described in the following in the description of embodiments and with reference to the enclosed figures. The drawings show the following:

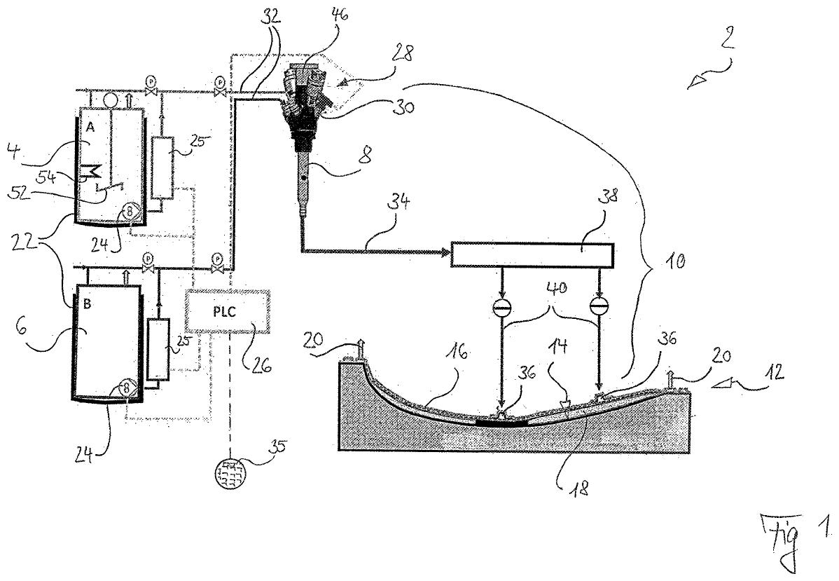

FIG. 1 shows a schematic flow diagram of a method according to the invention with members of a device system according to the invention, and

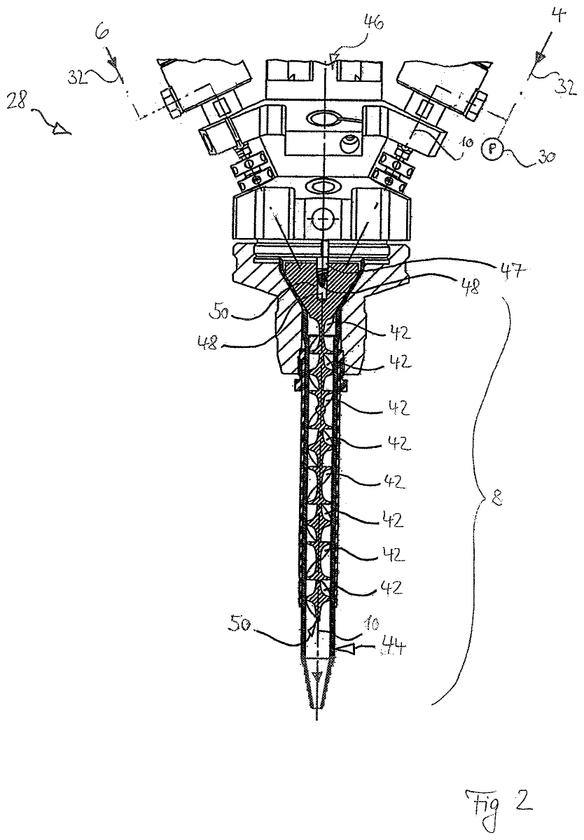

FIG. 2 shows a sectional side view of a mixing head of a device system according to the invention.

FIG. 1 shows a flow diagram 2 of a method for mixing a thermosetting plastic from two liquid components 4, 6 in a mixer 8 and conveying it for vacuum infusion through a line 10 into a mould 12 at a pressure lower than the ambient pressure.

The plastic is applied whilst still in liquid form to the rigid mould 12 that corresponds in a complementary manner to an outer side of the component, according to FIG. 1 to a side of a wind turbine blade (not shown). The plastic is applied to the rigid mould surface 14 underneath a film 16, the intermediate space 18 being placed under “vacuum”, i.e. subjected to negative pressure 20. In this intermediate space 18, the plastic impregnates fibre layers (not shown; for example woven fabric and/or laid fabric, in particular of glass) so that the component of fibre-reinforced plastic (namely, according to FIG. 1, a wind blade half-shell) is formed once the plastic has cured, since only the side formed by the rigid mould 12, 14 as the outer side of the future wind blade, and not the film side, can be reproduced in a dimensionally accurate manner. The vacuum 20 in the intermediate space 18 in the mould ensures that pockets of air which might otherwise form weak points later on are extracted—and in particular also that the liquid plastic is drawn into the fibre layers as a matrix. However, the pressure in the mould in the intermediate space 18 underneath the “vacuum film” 16 may not exceed the ambient pressure, not least because otherwise the film side 16 of the mould would be “blown up”.

The method now includes the steps of pumping the components from their own respective component container 22, by means of a respective pump 24 in each of the component containers 22, into the mixer 8 and mixing them therein. By means of a programmable logic controller 26, these volume flows (measured in volumetric flow meters 25) are controlled (by controlling the pumps 24—signal lines are shown as dashes) in such a manner that the components 4, 6 are supplied to the mixer 8 in the ratio required to produce the thermoset.

The volume flows are furthermore controlled by the controller 26 (again by controlling the pumps 24, namely with a priority inferior to the control of the mixing ratio) in such a manner that the components 4,6 are supplied to the mixer 8 at a pressure that is greater than the ambient pressure—namely greater by at most the pressure loss in the line from the mixer 8 to the mould 12.

The pressure in the mixed, liquid plastic is measured prior to mixing in the mixer 8 by a pressure sensor 30 in one of the two component supply lines 32 to mixer 8 (i.e. upstream of the mixer 8 with respect to the component flow direction) in the mixing head 28 (FIG. 2; more details below). The pressure sensor 30 is therefore only exposed to one of the more harmless, not yet mixed liquid components 4, and not, as is the case in the prior art, to the already mixed, already reacting, curing plastic that regularly renders the sensors at the sensitive measurement points inaccurate and unusable. The pressure at the sensor 30 in the component supply line 32 of the component 4 immediately upstream of the mixer 8 in the mixing head 28 is supplied to the controller 26. In the shown example, the configuration of the mixing head 28 and the arrangement of its components, including the sensor 30, is based on its construction for other methods for mixing two-component plastics.

The pressure loss in the line between the pressure sensor 30 and the mould 12 (or, for example, in a section 34 of the line 10 that is important for pressure loss, according to FIG. 1 up to a manifold 34; see below) can be measured (i.e. offline, for example determined in a preliminary test) before the actual manufacturing process is carried out, but can in particular also be calculated. The pressure loss occurs due to known laws of fluid mechanics, and thus the measurement and in particular also the calculation thereof are possible and objective, and are in particular not subject to any human discretion. According to the method, rheological, dynamic pressure losses, such as those due to fluid viscosity, line geometry and fluid friction in the line are, for example, taken into consideration in the calculation, but in particular also hydrostatic conditions, i.e. pressure loss (or increase) due to the amount of rise (or fall) between pressure measurement points 30 and the mould 12.

After inputting the line pressure loss into an input device 35 (and/or data supply line), the controller 26 controls the component volume flows in the lines 32 in particular in such a manner that the components 4, 6 are supplied to the mixer 8 at a pressure that is greater than the ambient pressure by at most the line pressure loss between the pressure sensors 30 and the mould 12. It is therefore ensured according to the invention that the film side 16 of the mould 12 is not blown up—namely even without having to measure the pressure in the intermediate space 18 of the mould, and in particular without having to measure it anywhere at all in the already mixed, still liquid plastic (for instance at the introduction points 36 into the mould 12, as according to the prior art; not shown).

As already indicated, the line 10 has a line section 34 or main line strand 34 from the measurement points 30 to a line manifold 38, as well as a plurality of local lines 40 (of varying lengths) leading from the line manifold 38 into the mould 18. This allows the mixed plastic to be guided from the mixer 8 to the manifold 38 through the main line strand 34 and, from the manifold, is introduced via branches into the intermediate space 18 of the mould 12 at a plurality of points 36 under the film 16. The amount of pressure loss in the local lines 40 is then preferably determined (i.e. measured and/or calculated) as being the amount of pressure loss in the local line with the lowest pressure loss and is supplied to the controller 26 to be taken into consideration when controlling the volume flows. Since these local lines run structurally parallel to one another from manifold 38 into mould 12, taking into consideration only one of the local lines, in particular the one with the lowest pressure loss, logically ensures that the pressure balance in each of the introduction points 36 from the local lines 40 into the mould 12 results in a pressure that is lower than the ambient pressure. Even taking into consideration the pressure loss in just one line section, for example in just the main line strand 34, will reliably ensure this according to the invention. The reason for this is that due to its logically shorter length than the whole line 10, a lower pressure loss will also be determined (in particular calculated and/or measured) in the line section 34. Since the volume flow is controlled according to the invention in such a manner that the pressure upstream of the mixer 8, measured at the sensors 30, is greater than the ambient pressure by (at most) the pressure loss, the liquid pressure at the inlets 36 into the mould 12, 18 will, given an actually even higher whole line pressure loss, accordingly be more significantly below ambient pressure.

By employing the shown device, a conventional so-called mixing head 28 is, as already stated, used in the shown method 2, such as is also used for other methods for mixing two-component plastics:

For the production of plastic prior to further processing, for example prior to introduction into the sprue of an injection mould, it is also the case for many plastics, in particular thermosets such as epoxy, that at least two liquid components, also in the prior art, are normally mixed together such that the resulting, in particular liquid (or also viscous, paste-like) mixture crosslinks. The component mixture is commonly forwarded for processing through a tubular passage (not shown), the—static— mixing insert, with turbulators in the interior thereof that deflect, divert and/or locally accumulate the fluid flowing therethrough, generate turbulence and/or swirl and thus mix the fluid flowing therethrough, possibly locally immediately before processing of the plastic. As is known, supply lines lead into this mixer, in particular in the same number as liquid components. A pressure sensor is in most cases arranged in at least one of the supply lines, which measures the fluid pressure in the still unmixed, i.e. not yet reacting, component.

In the method 2, production (mixing of the components 4, 6) takes place locally at a considerable distance from the processing of the plastic, vacuum injection thereof into the intermediate space 18 between the mould 14 and the film 16. However, in the method 2, such a conventional mixing head is also suitable as a mixer within the meaning of the invention and, optionally, its (at least one) pressure sensor 30 as a sensor within the meaning of the invention. This also applies to the so-called dynamic mixer 8 and mixing head 28 (shown in FIG. 2):

To ensure that the components 4, 6 are mixed as uniformly and completely as possible, it has proven to be advantageous and become established to configure the turbulators 42 in the tubular passage 44 such that they rotate. Mixing heads 28 then have at least two component supply lines 32 as well as a rotary drive 46 with a drive shaft 47. Such a device 28 is then adjusted to place the tubular passage member 44 (mixer tube) in fluid-tight conducting connection with the component supply lines 32, and to place a rotary drive connecting structure 48 in rotary drive connection 48 with a mixer insert 50 (typically comprising a number of turbulators 42 and being configured for use in the passage member 44) when the mixer insert 50 is inserted into the passage member 44 and the passage member is placed in conducting connection with the component supply lines. In known mixer inserts 50, such a rotary drive connecting structure is often an opening (not shown) lying substantially radial to the axis of rotation, into which a hook (not shown) at the end of the drive shaft is hooked in order to create the drive connection—shown, however, is a self-tapping thread 48 at the end of the drive shaft 47 in a bore 48 at the start of the mixer insert 50. The mixer tube 44 and mixer insert 50, which together are also called mixer 8, as well as the above-described static mixers (not shown) may (also according to the invention) be single-use or disposable articles.

A stirrer 52 (for example to homogenise the component) and/or a heater 54 (for example to keep the component temperature constant) may be provided in the component containers 22.

### LIST OF REFERENCE NUMBERS

Flow diagram 2 of a method according to the invention for mixing plastic
Two liquid components 4, 6
Mixer 8
Supply line 10
Mould 12
Mould surface 14
Film 16
Intermediate space 18
“Vacuum”; negative pressure 20
Component container 22
Pump 24
Volumetric flow meter 25
Programmable logic controller 26
Mixing head 28
Pressure sensors 30
Component supply lines 32 to the mixer 8 in the mixing head 28
Section important for pressure loss; main line strand 34 of line 10
Input (device) 35 of the line pressure loss
Introduction points 36 into the mould 12
Line manifold 38
Local lines 40
Turbulators 42
Tubular passage; mixer tube 44
Rotary drive 46
Drive shaft 47
Rotary drive connecting structure 48
Mixer insert 50
Stirrer 52
Heater 54

1. A method for mixing plastic from liquid components in a mixer and conveying the plastic through a line into a mould, in particular for vacuum infusion, at a pressure below ambient pressure or below another specific pressure that should not be exceeded in the mould, the method comprising acts of:
(a) pumping each of the components using a pump from a respective component container into a mixer and mixing the components therein,
(b) controlling volume flows using a controller in such a manner that the components are supplied to the mixer in a specific ratio,
(c) determining pressure loss in the line, between a pressure sensor in a component supply line leading to the mixer and the mould, and
(d) measuring the pressure in the component supply line using the pressure sensor and supplying the pressure to a controller which, taking into consideration the determined pressure loss, controls the volume flow of the component in the component supply line of the pressure sensor such that the pump supplies the component to the pressure sensor at a pressure that is greater than the ambient pressure or another specific pressure that should not be exceeded in the mould by at most the pressure loss.

2. A device for mixing plastic from liquid components in a mixer and conveying the plastic through a line into a mould, in particular for vacuum infusion, at a pressure below ambient pressure or below another specific pressure that should not be exceeded in the mould, the device comprising:
at least one pump that is configured to pump the components from a respective component container into a mixer that is configured to mix the components,
a controller that is configured to control volume flows in such a manner that the components are supplied to the mixer in a specific ratio,
a device that is configured to input and/or measure pressure loss in the line between a pressure sensor in a component supply line leading to the mixer and the mould, and
a controller that is configured to control, taking into consideration the determined pressure loss, the volume flow in the component supply line of the pressure sensor such that the component is supplied to the pressure sensor and from the pressure sensor to the mixer at a pressure measured by the pressure sensor that is greater than the ambient pressure or another specific pressure that should not be exceeded in the mould by at most the pressure loss.

3. The device according to claim 2, wherein the line includes a line strand from the mixer to a line manifold and a plurality of local lines leading from the line manifold into the mould.

4. The device according to claim 3, wherein the amount of pressure loss in the local lines is determined as the amount of pressure loss in the local line with the lowest pressure loss and is supplied to the controller to be taken into consideration when controlling the pumps.

5. The method according to claim 1, further comprising an act of degassing at least one of the components in the component container prior to performing acts (a) to (d).

6. The method or device according to claim 2, wherein the mixer is a mixing head with a drive device for a dynamic mixer insert.

7. The method according to claim 1, wherein the line includes a line strand from the mixer to a line manifold and a plurality of local lines leading from the line manifold into the mould.

8. The method according to claim 7, wherein act (c) includes determining the amount of pressure loss in the local lines as the amount of pressure loss in the local line with the lowest pressure loss and supplying the pressure loss to the controller to be taken into consideration when controlling the pumps.

9. The method according to claim 1, wherein the mixer is a mixing head with a drive device for a dynamic mixer insert.
